(19) United States
(12) Patent Application Publication
(10) Pub. No.: US 2026/0127119 A1
(43) Pub. Date: May 7, 2026

(54) MEMORY CONTROLLER FOR PROCESSING IN MEMORY AND MEMORY GENERATION METHOD USING MEMORY CONTROLLER

(71) Applicant: SAMSUNG ELECTRONICS CO., LTD., Suwon-si (KR)

(72) Inventors: Seungwoo SEO, Suwon-si (KR); Sunjung LEE, Suwon-si (KR); Yeongon CHO, Suwon-si (KR)

(73) Assignee: SAMSUNG ELECTRONICS CO., LTD., Suwon-si (KR)

(21) Appl. No.: 19/377,787

(22) Filed: Nov. 3, 2025

(30) Foreign Application Priority Data
Nov. 5, 2024 (KR) 10-2024-0155324

(51) Int. Cl. G06F 13/16; G06F 17/16

(52) U.S. Cl. CPC G06F 13/1673; G06F 13/1642; G06F 17/16

(57) ABSTRACT

A processing in memory (PIM) command generator for a PIM device includes: an input buffer, wherein the PIM command generator is configured to: store input data into the input buffer in response to receiving, from a host, a first PIM request indicating to write the input data; receive, from the host, a second PIM request indicating a PIM operation between the input data and data stored in the PIM device; in response to the second PIM request, scanning elements of the input data stored in the input buffer to generate a PIM command corresponding to a non-zero element among the input data and to skip generating a PIM command corresponding to a zero element; and transmit the generated PIM command to the PIM device.

### CROSS-REFERENCE TO RELATED APPLICATIONS

This application claims the benefit under 35 USC § 119(a) of Korean Patent Application No. 10-2024-0155324, filed on Nov. 5, 2024, in the Korean Intellectual Property Office, the entire disclosure of which is incorporated by reference herein for all purposes.

### BACKGROUND

### 1. Field

The following description relates to a memory controller for a processing in memory (PIM) device.

### 2. Description of Related Art

With the rise of large-scale artificial intelligence (AI) models (e.g., large language models (LLMs)), there is a growing trend toward increasingly larger AI models. An LLM may generally be divided into a summarization stage and a generation stage. However, as the size of AI models increases and the number of tokens generated based on the AI models grows, the processing time of the generation stage may dominate the overall operation time of an AI model due to high memory bandwidth demand significantly exceeding available memory bandwidth capacity. To address this memory bandwidth issue, processing-in-memory (PIM) is being studied.

PIM devices not only function as memory devices by storing data but also include a function to process the data directly within the memory. Mathematical operations may be performed by a PIM device on data stored therein both before, during, and after the mathematical operations, and results of the mathematical operations may be stored in or outputted from the PIM device. PIM technology can improve overall system performance by performing computations closer to the memory, thereby reducing data transfer bottlenecks between the memory and a host processor. A memory device with PIM technology may integrate operation units or processing cores near memory cells, enabling a processing task to be performed within the memory without the need to temporarily move data in and out of the memory. As a result, the load on the host processor may be reduced, host processor idle time may be reduced, power consumption may be decreased, and data processing speed may be improved.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processing in memory (PIM) command generator for a PIM device includes: an input buffer, wherein the PIM command generator is configured to: store input data into the input buffer in response to receiving, from a host, a first PIM request indicating to write the input data; receive, from the host, a second PIM request indicating a PIM operation between the input data and data stored in the PIM device; in response to the second PIM request, scanning elements of the input data stored in the input buffer to generate a PIM command corresponding to a non-zero element among the input data and to skip generating a PIM command corresponding to a zero element; and transmit the generated PIM command to the PIM device.

The PIM command generator may further include: one or more registers configured to store scanning information including tiling information of the PIM device, hardware information of the PIM device, or address mapping information, wherein the scanning may be performed based on the scanning information.

The second PIM request may indicate a matrix-vector multiplication operation between a matrix stored in memory of the PIM device and an input vector stored as input data in the input buffer of the PIM device, and wherein the memory of the PIM device performs the matrix-vector multiplication operation.

The PIM command generator may be configured to: in response to the second PIM request, determine, based on a first element among the elements of the input vector being non-zero, a memory address of at least a portion of the matrix to be multiplied by the first element; and based on a second element among the elements of the input vector being zero, skip determining a memory address of at least a portion of the matrix to be multiplied by the second element among the memory of the PIM device.

The PIM command generator may be configured to: based on tiling information of the PIM device, divide the matrix into one or more memory tiles; with respect to each memory tile having an element to be multiplied by the first element among the one or more memory tiles, generate one PIM command indicating multiplication between the first element and a column of a corresponding memory tile corresponding to the first element and indicating accumulation of each multiplication result into an element of a corresponding output vector.

The PIM command generator may be configured to: based on information indicating each non-zero element among the input data and based on information about the PIM device, determine an address of a memory area corresponding to a corresponding element among memory of the PIM device; and generate one or more PIM commands using the element and the address of the memory area.

The PIM command generator may be configured to transmit one or more generated PIM commands to a memory command queue.

In another general aspect, an electronic device includes: a processing in memory (PIM) command generator configured to generate, based on a PIM request received from a host, one or more PIM commands configured to implement the PIM request when executed by a PIM device, wherein the PIM command generator includes an input buffer, and wherein the PIM command generator is configured to: store the input data in the input buffer in response to receiving a first PIM request indicating to write input data; receive a second PIM request indicating a PIM operation between the input data and data stored in a PIM device; in response to the second PIM request, scanning elements of the input data stored in the input buffer to determine to skip generating a PIM command corresponding to a first element of the input data based on the first element being zero and to determine to generate a PIM command corresponding to a second element of the input data based on the second element being non-zero; and transmit the generated PIM command to the PIM device.

The electronic device may further include: an arbiter configured to determine whether to classify a memory request received from the host as a standard memory request or as a PIM request; and a standard command generator, wherein the arbiter is configured to: based on classifying a first memory request as a standard memory request, transmit the first memory request to the standard command generator; and based on classifying a second memory request as a PIM request, transmit the second memory request to the PIM command generator, wherein the standard command generator is configured to generate a standard memory command based on receiving the first memory request from the arbiter, and wherein the PIM command generator is configured to generate the one or more PIM commands based on receiving the second memory request from the arbiter.

The PIM command generator may further include one or more registers configured to store scanning information including tiling information of the PIM device, hardware information of the PIM device, or address mapping information, wherein the scanning is performed based on the scanning information.

The second PIM request may indicate a matrix-vector multiplication operation between a matrix stored in a memory of the PIM device and an input vector stored as input data in the input buffer.

Generating the PIM command may include determining a memory address of at least a portion of the matrix to be multiplied by the first element.

The PIM command generator may be configured to: based on tiling information of the PIM device, divide the matrix into one or more memory tiles; and with respect to each memory tile having an element to be multiplied by the first element among the one or more memory tiles, generate one respective PIM command indicating multiplication between the first element and a column of a corresponding memory tile corresponding to the first element and indicating accumulation of each multiplication result into an element of a corresponding output vector.

The PIM command generator may be configured to: determine, based on information indicating each non-zero element among the input data, information about the PIM device, an address of a memory area corresponding to a corresponding element, the memory area in memory of the PIM device; and generate one or more PIM commands using the element and an address of the memory area.

The electronic device may further include: a memory command queue, and the PIM command generator may be configured to transmit the generated one or more PIM commands to the memory command queue.

The electronic device may further include: a standard command generator; a standard memory command queue; and a PIM command queue, wherein the PIM command generator is configured to transmit the generated one or more PIM commands to the PIM command queue, and wherein the standard command generator is configured to generate, based on a standard memory request received from the host, a standard memory command and then transmit the generated standard memory command to the standard memory command queue.

The electronic device may further include: a scheduler connected to the standard memory command queue and the PIM command queue, wherein the scheduler is configured to: determine, through scheduling, one queue among the standard memory command queue or the PIM command queue; and transmit, to the PIM device, at least one of the standard memory command or the PIM command received from the determined one queue.

In another general aspect, a method of generating a memory command is performed by a processing in memory (PIM) command generator configured to generate commands to be executed by a PIM device, and the method includes: storing input data into an input buffer of the PIM command generator, the storing in response to receiving, from a host, by the PIM command generator, a first PIM request indicating to write input data; receiving, from the host, by the PIM command generator, a second PIM request indicating a PIM operation between the input data and data stored in the PIM device; in response to the second PIM request, scanning elements of the input data stored in the input buffer, and based on the scanning generating a PIM command corresponding to a non-zero element among the input data and further based on the scanning skipping generating a PIM command corresponding to a zero element; and transmitting, by the PIM command generator, the generated PIM command to the PIM device.

The second PIM request may be configured to indicate a matrix-vector multiplication operation between a matrix stored in a memory of the PIM device and the input vector stored as the input data in the input buffer.

A non-transitory computer-readable storage medium stores commands that, when executed by one or more processors, cause the one or more processors to perform any of the methods.

Other features and aspects will be apparent from the following detailed description, the drawings, and the claims.

### BRIEF DESCRIPTION OF THE DRAWINGS

FIG. 1 illustrates an example of a memory system, according to one or more embodiments.

FIG. 2 illustrates an example of a method in which zero-skipping is performed by a processing in memory (PIM) generator of a memory controller, according to one or more embodiments.

FIG. 3 illustrates an example of an operation in which a memory controller outputs, based on a memory request, a memory command, according to one or more embodiments.

FIG. 4A illustrates an example of an operation in which a PIM operation generator generates memory commands for a matrix-vector multiplication operation without performing zero-skipping, according to one or more embodiments.

FIG. 4B illustrates an example of an operation in which the PIM operation generator generates a memory command for a matrix-vector multiplication operation by performing zero-skipping, according to one or more embodiments.

FIG. 5 illustrates an example of a configuration of a PIM command generator, according to one or more embodiments.

FIG. 6 illustrates an example of a memory system including a direct memory access (DMA) device, according to one or more embodiments.

Throughout the drawings and the detailed description, unless otherwise described or provided, it may be understood that the same or like drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

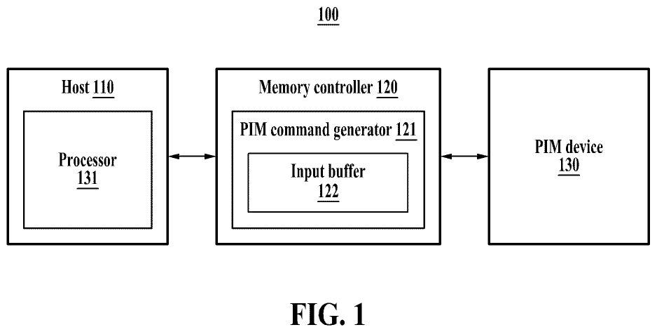

FIG. 1 illustrates an example of a memory system, according to one or more embodiments.

A memory system 100 may include a host 110, a memory controller 120, and a processing in memory (PIM) device 130.

The host 110 may include a processor 131. The host 110 may generate and transmit a memory request to the PIM device 130. The processor 131 of the host 110 may be a central processing unit (CPU), a graphics processing unit (GPU), and/or a neural processing unit (NPU), for example.

In response to a memory request received from the host 110, the memory controller 120 may generate one or more memory commands for performing an operation indicated by the memory request. The memory controller 120 may transmit, to the PIM device 130, the generated one or more memory commands, which the PIM device 130 may execute.

The PIM device 130 may include a memory, and the memory may have a PIM technique applied thereto. The PIM technique may be a technique that, while supporting a data read operation and/or a data write operation like a conventional memory device, additionally supports a function (e.g., an arithmetic operation) to process data within the memory (generally, without having to move the data to perform the processing function, i.e., the function may be performed with the data in-place in the memory). As the data processing load of the host 110 and/or the amount of movement of data in a system is reduced through the PIM technique, the performance of the memory system 100 may increase.

The memory controller 120 may include a PIM command generator 121. The memory controller 120 may transmit, to the PIM device 130, a memory command indicating at least a portion of a matrix-vector multiplication operation. The matrix-vector multiplication operation may include multiplication between a matrix stored in a memory area of the PIM device 130 and a vector obtained from the host 110. That is, the matrix-vector multiplication operation may have the in-memory matrix in the PIM device 130 (before, during and after the operation) as one parameter and the vector inputted. An input buffer 122 may store an input vector obtained from the host 110. The PIM command generator 121 may generate one or more memory commands implementing multiplication between at least a portion of the input vector stored in the input buffer 122 and at least a portion of the matrix.

However, when there is a zero element (e.g., bit) among elements of the input vector, since multiplication between the zero element of the input vector and element(s) of a matrix does not have an impact on the final result of the matrix-vector multiplication operation, the multiplication between the zero element of the input vector and an element of the matrix may be skipped. With respect to each of the elements of the input vector stored in the input buffer 122, when an element is zero, the memory controller 120 and/or the PIM command generator 121 may skip generating a memory command indicating a multiplication operation related to the that element. Skipping multiplication for an element based on the element of the input vector being zero can be referred to as zero-skipping. For example, zero-skipping may reduce the number of operations of the PIM device 130 in a training operation or an inference operation of a machine learning model being performed with matrix-vector multiplication operation(s), thereby efficiently obtaining the same result of the operation as if zero-skipping had not been performed. Zero-skipping may be determined/controlled by a device (e.g., the memory controller 120) external to the PIM device 130 instead of control logic included in the PIM device 130, and thus, internal processing overload of the PIM device 130 may be prevented.

FIG. 1 illustrates the host 110 and the memory controller 120 as separate devices, but examples are not limited thereto. For example, the host 110 may include the memory controller 120.

Although not illustrated in FIG. 1, a direct memory access (DMA) device may transmit a memory request to the PIM 130 independently of (e.g., not through the host 110) the host 110. For example, the memory system 100 may further include a DMA device and a DMA controller. The DMA controller may receive, from the DMA device, a first memory request for the PIM device 130. The DMA controller may generate one or more second memory requests corresponding to the first memory request. The DMA controller may transmit, to the memory controller 120, the one or more second memory requests. The memory controller 120 may generate memory command(s) based on the one or more second memory requests received from the DMA controller.

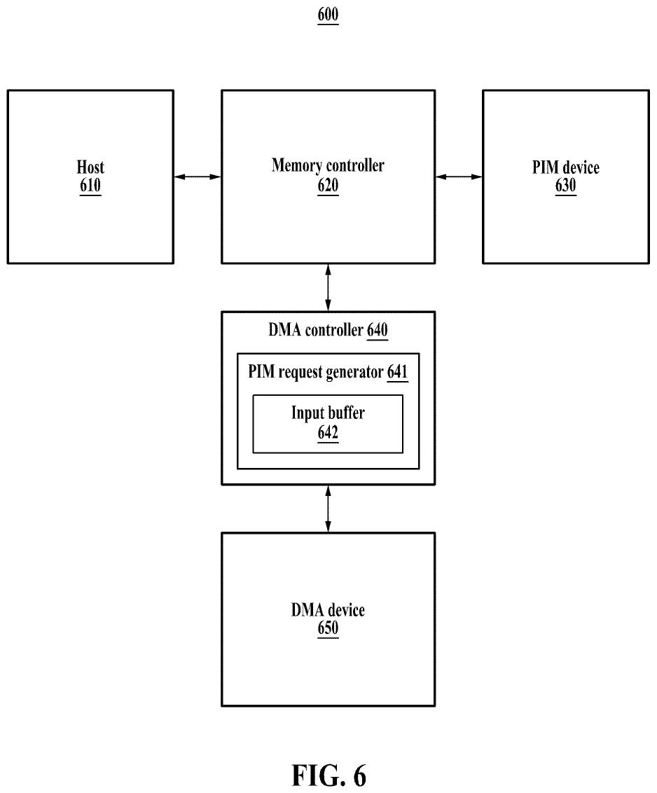

The DMA controller may perform/control zero-skipping. For example, the DMA controller may further include a PIM request generator. The PIM request generator may further include an input buffer to store an input vector of a matrix-vector multiplication operation. In order to skip a multiplication operation between a zero element of the input vector and an element of a matrix, the PIM request generator may generate, in the same/similar manner as the PIM command generator 121, a memory request indicating to limit (e.g., skip) generation of a memory request (and/or a memory command) indicating a multiplication operation between a zero element of the input vector and an element of the matrix. However, when the memory system 100 includes the DMA device and the DMA controller, zero-skipping is not necessarily performed by the DMA controller but may be performed by the PIM command generator 121 included in the memory controller 120 instead of the DMA controller. A version of the memory system 100 that includes both the DMA device and the DMA controller is described with reference to FIG. 6.

A memory controller and a DMA controller may be collectively referred to as an “electronic device”.

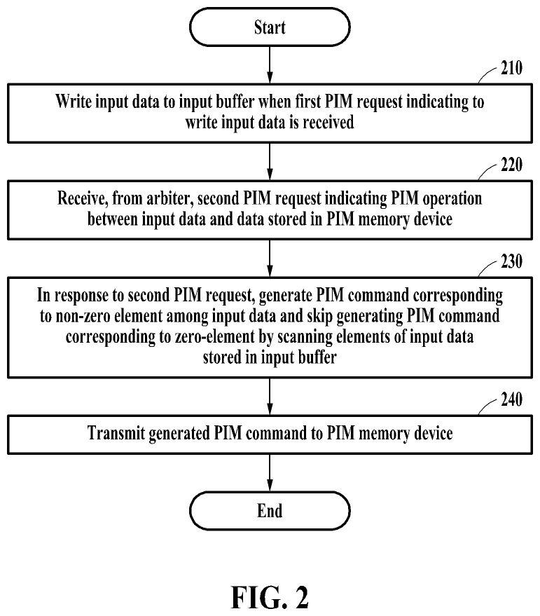

FIG. 2 illustrates an example of a method in which zero-skipping is performed by a PIM generator of a memory controller, according to one or more embodiments.

A memory controller (e.g., the memory controller 120 of FIG. 1) for a PIM device (e.g., the PIM device 130 of FIG. 1) may include a PIM command generator (e.g., the PIM command generator 121 of FIG. 1). The PIM command generator may generate, based on a PIM request received from a host, for example, one or more PIM commands. A PIM request is a type of memory request and may include a request related to a PIM operation (e.g., a matrix-vector multiplication operation) of data stored in the PIM device. The PIM command generator may include an input buffer (e.g., the input buffer 122 of FIG. 1). As described above with reference to FIG. 1, in the process of generating a memory command, the memory controller may generate the memory command to indicate a matrix-vector multiplication operation based on whether an element of an input vector is zero.

In operation 210, when receiving a first PIM request indicating to write input data (a write request), the PIM command generator may store the input data in the input buffer (to be available in the PIM device for use as an operand). As described below, the input data may be used as an input vector (operand) of a matrix-vector multiplication operation.

After operation 210, in operation 220, the PIM command generator may receive another PIM request (a second PIM request) indicating a PIM operation between the input data and data stored in the PIM device. The PIM operation may be/include a matrix-vector multiplication operation, for example. In a matrix-vector multiplication operation, the input data stored in the input buffer may be used as an input vector (a first multiplication operand) and the data stored in the PIM device may be used as a matrix (a second multiplication operand).

The second PIM request may include a memory address indicating a memory area in a memory of the PIM device, the memory area being where a matrix is stored. The second PIM request may include information indicating whether to perform zero-skipping. When the second PIM request indicates to that zero-skipping is to be performed, the PIM command generator may perform an operation (e.g., operation 230) of skipping generating at least one PIM command, which may be done through scanning an element of the input data.

When the second PIM request indicates not to perform zero-skipping, the PIM command generator may generate a memory command for each element of the input data without performing an operation (e.g., operation 230) of scanning an element of the input data and/or skipping generating at least one PIM command.

In operation 230, in response to the second PIM request, the PIM command generator may generate a PIM command corresponding to a non-zero element among the input data and may skip generating a PIM command corresponding to a zero-element, and may do so by scanning elements of the input data stored in the input buffer. The generated PIM command may be a memory command for performing at least a portion of a PIM operation in the PIM device.

When a first element among elements of the input data is zero, the PIM command generator may skip generating a PIM command indicating a multiplication operation related to the first element while performing a matrix-vector multiplication operation, since multiplication between the first element and elements of a matrix has no impact on the overall result being computed for the second PIM request.

When a second element among the elements of the input data is non-zero, the PIM command generator may generate a PIM command indicating a multiplication operation related to the second element while performing a matrix-vector multiplication operation, since multiplication between the second element and elements of a matrix has an impact on the overall result.

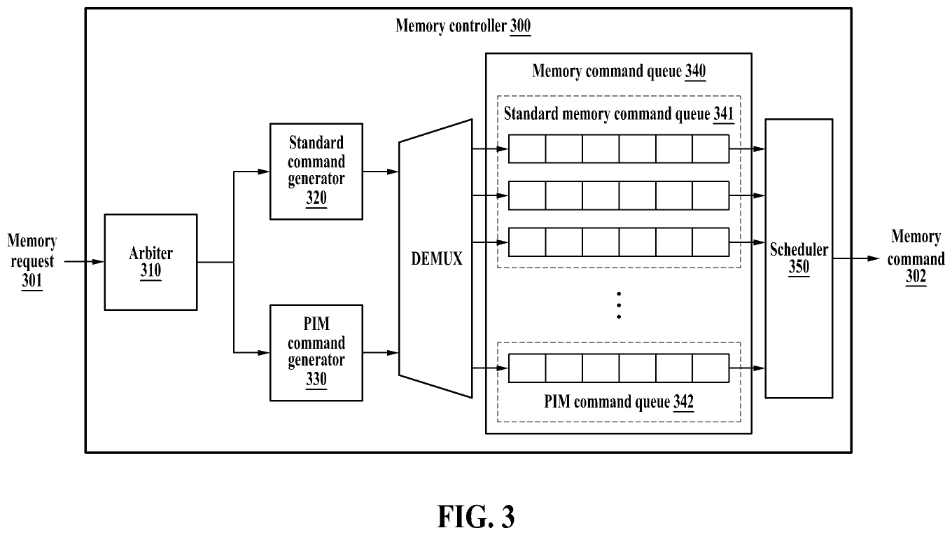

In operation 240, the PIM command generator may transmit the generated PIM command to the PIM device. As described below with reference to FIG. 3, the memory controller may insert the generated PIM command to a memory command queue from where a scheduler may schedule its transmission to the PIM device.

FIG. 3 illustrates an example of an operation in which a memory controller outputs, based on a memory request, a memory command, according to one or more embodiments.

A memory controller 300 (e.g., the memory controller 120 of FIG. 1) may include an arbiter 310, a standard command generator 320, and a PIM command generator 330 (e.g., the PIM command generator 121 of FIG. 1). Regarding the “request” and “command” terminology, a memory request is generally an application-level type of request, and the memory controller 300 may translate the memory request into one or more memory commands (including a PIM command) that are actionable by the target PIM device (e.g., PIM device 130).

The memory controller 300 may receive a memory request 301 from a host (e.g., the host 110 of FIG. 1).

The arbiter 310 may analyze the memory request and classify the memory request 301 as a standard memory request or a PIM request. The classifying may be done according to a mode (e.g., a standard mode or a PIM mode) of the memory controller 300. Additionally or alternatively, the classifying may be based on information (e.g., a flag) included in the memory request 301.

When the memory request 301 is classified as a standard memory request, the arbiter 310 may transmit the memory request 301 to the standard command generator 320. In turn, the standard command generator 320 may generate a standard memory command based on receiving the memory request 301 from the arbiter 310. The standard memory command is a type of a memory command 302 and is generally a non-PIM command, for example, a read command or a write command (although there may be PIM read and write commands).

The standard command generator 320 may transmit the generated standard memory command to a demultiplexer (DEMUX). The arbiter 310 and/or the standard command generator 320 may transmit, to the DEMUX, a select signal for selecting one of the queues included in a memory command queue 340 together with the generated standard memory command.

When the memory request 301 is classified as a PIM request, the arbiter 310 may transmit the memory request 301 to the PIM command generator 330. The PIM command generator 330 may generate one or more PIM commands based on receiving the memory request 301 from the arbiter 310. As described above with reference to FIG. 2, a PIM command is a type of the memory command 302 and may be the memory command 302 for performing at least a portion of a PIM operation in a PIM device (e.g., the PIM device 130 of FIG. 1). The PIM command generator 330 may transmit the generated PIM command to the DEMUX. The arbiter 310 and/or the PIM command generator 330 may transmit, to the DEMUX, a select signal for selecting, from the memory command queue 340, one of memory command queues, together with the generated PIM command.

The memory command queue 340 may be a memory for storing the memory command 302 generated by a command generator (e.g., the standard command generator 320 or the PIM command generator 330). The memory command queue 340 may include one or more queues. A queue may be implemented as at least one of a buffer, a register, or static random access memory (SRAM), for example.

The memory command queue 340 may include a standard memory command queue 341 and a PIM command queue 342. The standard memory command queue 341 may be the memory command queue 340 that stores standard memory commands. The PIM command queue 342 may store PIM commands. Each of the standard memory command queue 341 and the PIM command queue 342 may include one or more distinct queues. The standard memory command and the PIM command may be stored in the standard memory command queue 341 and the PIM command queue 342, respectively.

For example, the PIM command generator 330 may transmit, to the PIM command queue 342, one or more PIM commands generated thereby. The PIM command queue 342 may store the one or more PIM commands received from the PIM command generator 330.

For example, the standard command generator 320 may transmit standard memory command(s) generated thereby to the standard memory command queue 341. The standard memory command queue 341 may store the standard memory command(s) received from the standard command generator 320.

Referring to FIG. 3, the memory controller 300 may include a DEMUX between a command generator (e.g., the standard command generator 320 or the PIM command generator 330) and the memory command queue 340. The DEMUX may use information (e.g., a select signal) received together with each memory command 302 to transmit/transfer a corresponding memory command 302 to a determined queue among the queues of the memory command queue 340.

The memory controller 300 may further include a scheduler 350 connected to the standard memory command queue and the PIM command queue 342. The scheduler 350 may determine/select, through scheduling, one queue among the standard memory command queue 341 or the PIM command queue 342. The scheduler 350 may transmit, to the PIM device, at least one of the standard memory command or the PIM command from the determined one queue.

Each of the arbiter 310, the standard command generator 320, the PIM command generator 330, the DEMUX, the memory command queue 340, and the standard memory command queue 341, the PIM command queue 342, and the scheduler 350 of the memory controller 300 may be implemented as a hardware module including one or more memory units and/or circuitry units.

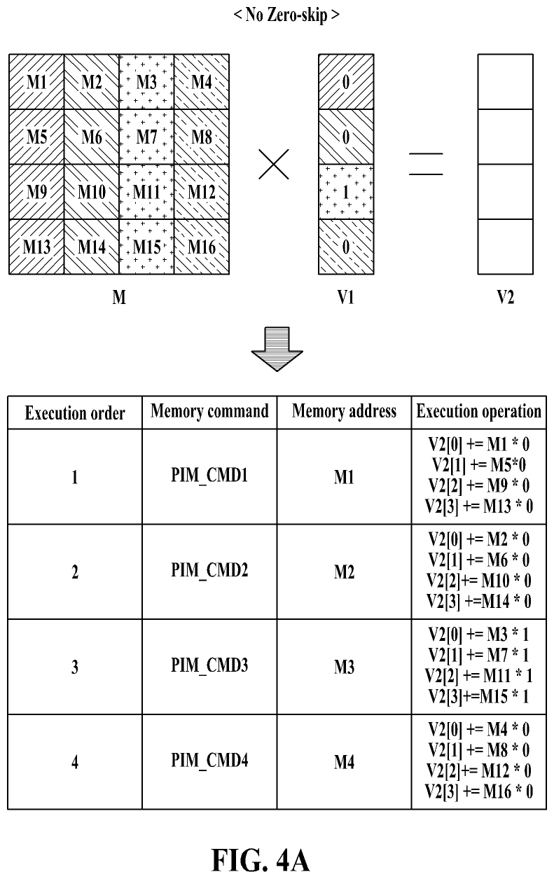

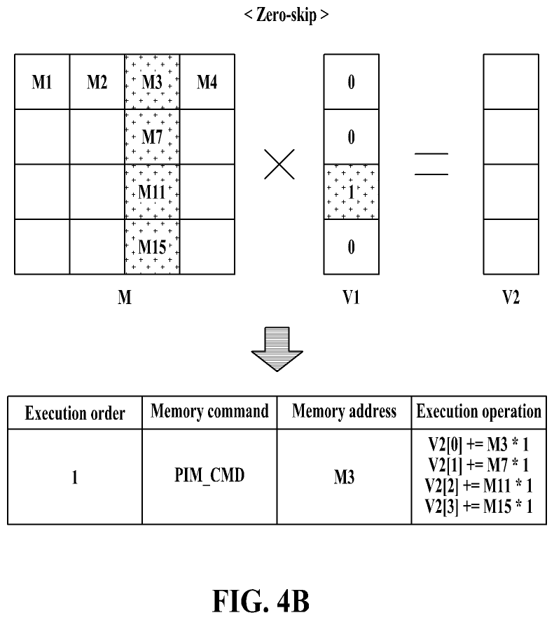

FIG. 4A illustrates an example of an operation in which a PIM operation generator generates memory commands for a matrix-vector multiplication operation without performing zero-skipping, according to one or more embodiments.

Referring to FIG. 4A, a memory controller (e.g., the memory controller 120 of FIG. 1 and the memory controller 300 of FIG. 3) may receive a first PIM request that requests to write an input vector V1 to an input buffer (e.g., the input buffer 122 of FIG. 1). For example, the input vector V1 may be a 4×1 vector, a first element V1[0] of the input vector V1 may be zero, a second element V1[1] may be zero, a third element V1[2] may be non-zero (e.g., 1), and a fourth element V1[3] may be zero.

The memory controller may receive a second PIM request. The second PIM request may indicate a matrix-vector multiplication operation between a matrix M stored in a memory of a PIM device (e.g., the PIM device 130 of FIG. 1) and an input vector (e.g., the vector V1) stored in an input buffer. For example, the matrix M may be a 4×4 matrix and have 16 elements (e.g., a first element M1 to a sixteenth element M16). The second PIM request may include a memory address indicating a memory area of the PIM device in which the matrix M (specified operand) is stored. The second PIM request may include information indicating not to perform zero-skipping. Based on information (e.g., a predetermined bit and/or a flag) indicating not to perform zero-skipping included in the second PIM request, the PIM command generator (e.g., the PIM command generator 121 of FIG. 1 and the PIM command generator 330 of FIG. 3) may generate memory command(s) corresponding to respective elements of the input vector V1 without skipping generation of any memory command(s) (command(s) for complete matrix-vector multiplication).

The PIM command generator may divide, using PIM device information (e.g., tiling information and hardware information), a portion (e.g., a column) to be multiplied by each element of input data in the matrix M into one or more partial columns that may be processed by the PIM device in parallel. A partial column may be divided such that multiplication and/or accumulation between each of elements included in the partial column and a predetermined element of the input data may be performed in parallel.

The PIM command generator may further include one or more registers that store PIM device information. The PIM device information may be about a PIM device and may include at least one of tiling information, hardware information, or address mapping information. The one or more registers may be implemented as/in a register file.

Hardware information may be a hardware resource that the PIM device may use for a PIM operation. For example, the hardware information may include the number of registers that may be used for the PIM operation, the number of memory channels of the PIM device, the number of memory ranks of the PIM device, the number of memory bank groups of the PIM device, the number of memory banks of the PIM device, and/or the number of processing units (e.g., an operator) of the PIM device. The PIM device information may be stored into the one or more registers based on a configuration request received from a host. The address mapping information may include mapping information between a physical address of the host (e.g., the host 110 of FIG. 1) and a memory address of the PIM device (e.g., the PIM device 130 of FIG. 1).

The PIM command generator may determine, based on the hardware information, the size of a memory tile as tiling information. The PIM command generator may write the determined tiling information to one or more registers. A memory tile is a matrix having a predetermined size and may be a memory area of a size in which the PIM device may perform multiplication and accumulation operations in parallel between each element of the input vector and elements (e.g., elements of one column of the memory tile) related to a corresponding element in a matrix. For example, the PIM command generator may determine, based on the hardware information, that the size of a memory tile is 4×4. As described below, the PIM command generator may divide a matrix into one or more memory tiles and generate one or more memory commands, based on/for each memory tile.

For example, the PIM command generator may divide, based on tiling information, the matrix M into one or more memory tiles. When dividing the matrix M into memory tiles, the PIM command generator may divide the input vector V1 into sub-vectors corresponding to the memory tiles, respectively. When determining that the matrix M is a memory tile, the PIM command generator may skip (or determine that an input vector is a sub-vector) dividing the input vector V1.

In FIG. 4A, based on the size (e.g., 4×4) of the matrix M, which is an operand of a matrix-vector multiplication operation, being less than or equal to the size (e.g., 4×4) of a memory tile, the PIM command generator may determine that the matrix M is a memory tile (or may be treated as such). Based on determining that the matrix M is a memory tile, the PIM command generator may skip dividing the input vector V1.

With respect to each memory tile having an element to be multiplied by each element of the input vector V1, the PIM command generator may generate a PIM command indicating multiplication between a column corresponding to a corresponding element of a corresponding memory tile and the corresponding element and accumulation of multiplication results.

In FIG. 4A, with respect to a memory tile (e.g., the matrix M) having an element to be multiplied by the first element V1[0] of the input vector V1, the PIM command generator may generate a PIM command (e.g., a first PIM command PIM_CMD1). In other words, based on each element of the input vector V1 and a memory tile corresponding to a corresponding element, the PIM command generator may generate a PIM command. The generated first PIM command PIM_CMD1 may indicate multiplication between the first element V1[0] of a memory tile and a column (e.g., a column including a first element M1, a fifth element M5, a ninth element M9, and a thirteenth element M13) and accumulation of respective multiplication results to corresponding elements of an output vector V2. In FIG. 4A, multiplication and accumulation operations indicated by the first PIM command (PIM_CMD1) may be expressed by equations in the execution operation column of Execution order 1. In FIG. 4A, V2 denotes the output vector V2, V2[0] denotes a first element of the output vector V2, V2[1] denotes a second element of the output vector V2, V2[2] denotes a third element of the output vector V2, and V2[3] denotes a fourth element of the output vector V2.

Similarly, with respect to each of the second element V1[1], the third element V1[2], and the fourth element V1[3] of the input vector V1, the PIM command generator may generate a PIM command for a corresponding memory tile (e.g., the matrix M). For example, the PIM command generator may generate a second PIM command PIM_CMD2 for the second element V1[1] of the input vector V1. The PIM command generator may generate a third PIM command PIM_CMD3 for the third element V1[2] of the input vector V1. The PIM command generator may generate a fourth PIM command PIM_CMD4 for the fourth element V1[3] of the input vector V1.

However, as illustrated in FIG. 4A, the first PIM command PIM_CMD1, the second PIM command PIM_CMD2, and the fourth PIM command PIM_CMD4, although performed, do not have an impact on the output vector V2, based on the first element V1[0], the second element V1[1], and the fourth element V1[3] of the input vector V1 being zero. Through zero-skipping, the PIM command generator may skip generating the first PIM command PIM_CMD1, the second PIM command PIM_CMD2, and the fourth PIM command PIM_CMD4. The generation of a PIM command using zero-skipping is described with reference to FIG. 4B.

FIG. 4B illustrates an example of an operation in which the PIM operation generator generates a memory command for a matrix-vector multiplication operation by performing zero-skipping, according to one or more embodiments.

Referring to FIG. 4B, the memory controller (e.g., the memory controller 120 of FIG. 1 and the memory controller 300 of FIG. 3) may receive the first PIM request that requests to write the input vector V1 to the input buffer (e.g., the input buffer 122 of FIG. 1). In the same manner or similarly to FIG. 4A, for example, the input vector V1 may be a 4×1 vector, the first element V1[0] of the input vector V1 may be zero, the second element V1[1]) may be zero, the third element V1[2] may be non-zero (e.g., 1), and the fourth element V1[3] may be zero.

The memory controller may receive a second PIM request. In the same manner or similarly to FIG. 4A, the second PIM request may indicate a matrix-vector multiplication operation between the matrix M stored in a memory of the PIM device (e.g., the PIM device 130 of FIG. 1) and the input vector V1 stored in the input buffer. For example, the matrix M may be a 4×4 matrix and have 16 elements (e.g., the first element M1 to the sixteenth element M16). The second PIM request may include a memory address indicating a memory area of the PIM device in which the matrix M is stored.

Unlike the case of FIG. 4A, the second PIM request may include information indicating to perform zero-skipping. Based on information (e.g., a predetermined bit and/or flag) indicating to perform zero-skipping included in the second PIM request, the PIM command generator (e.g., the PIM command generator 121 of FIG. 1 and the PIM command generator 330 of FIG. 3) may skip generating memory command(s) (or generate commands to that effect) corresponding to respective elements of the input vector V1 according to whether a corresponding element is zero or non-zero.

Based on information (e.g., an index) indicating each non-zero element (e.g., the third element V1[2]) of the input data (e.g., the input vector V1) and information (e.g., tiling information and hardware information) related to the PIM device, the PIM command generator may determine an address of a memory area (e.g., a matrix column) corresponding to a corresponding element in the memory of the PIM device. The PIM command generator may generate one or more PIM commands using an element and an address of a memory area.

Based on whether each element is zero or non-zero, the PIM command generator may determine whether to determine an address of a memory area corresponding to a corresponding element by scanning elements of the input vector V1.

For example, in response to the second PIM request, the PIM command generator may determine, based on a predetermined element of the input vector V1 being non-zero, a memory address of at least a portion (e.g., the entire column or a portion of a column) of the matrix M to be multiplied by the predetermined element. The PIM command generator may generate one or more PIM commands using the determined memory address and the predetermined non-zero element.

For example, based on the predetermined element of the input vector V1 being zero, the PIM command generator may skip determining a memory address of at least a portion of the matrix M to be multiplied by the predetermined element in the memory of the PIM device. The PIM command generator may skip generating PIM command(s) related to a predetermined element by skipping determining a memory address.

The PIM command generator may determine, based on tiling information, at least a portion of the matrix M to be multiplied by the predetermined element. For example, the PIM command generator may divide, based on the tiling information of the PIM device, the matrix M into one or more memory tiles. With respect to each of the memory tiles having an element to be multiplied by the predetermined element among the one or more memory tiles, the PIM command generator may generate a PIM command indicating multiplication between (i) a column corresponding to a predetermined element among corresponding memory tiles and (ii) a predetermined element and accumulation of respective multiplication results to a corresponding output vector V2.

In the same manner or similarly to FIG. 4A, the PIM command generator may further include one or more registers for storing PIM device information, and tiling information (e.g., the size of a memory tile) may be determined to be 4×4. Based on the size (e.g., 4×4) of the matrix M, which is an operand of a matrix-vector multiplication operation, being less than or equal to the size (e.g., 4×4) of a memory tile, the PIM command generator may determine that the matrix M is a memory tile. Based on determining that the matrix M is a memory tile, the PIM command generator may skip dividing the input vector V1.

While sequentially scanning elements of the input vector V1, with respect to each memory tile having an element to be multiplied by a non-zero element of the input vector V1, the PIM command generator may generate a PIM command indicating multiplication between (i) a column of a corresponding memory tile corresponding to a corresponding element and (ii) a corresponding element, followed by accumulation of multiplication results.

For example, as illustrated in FIG. 4B, the PIM command generator may skip, based on the first element V1[0] of the input vector V1 being zero, determining the address of a memory area corresponding to the first element V1[0] and may skip generating a corresponding PIM command.

Based on the second vector V1[1] of the input vector V1 being zero, the PIM command generator may skip determining the address of a memory area corresponding to the second element V1[1] and may skip generating a corresponding PIM command.

Based on the third element V1[2] of the input vector V1 being non-zero, the PIM command generator may determine the address of a memory area corresponding to the third element V1[2] and generate a PIM command related to the third element V1[2] using the determined address of the memory area. For example, with respect to a memory tile (e.g., the matrix M) having an element (e.g., the third element M3, the seventh element M7, the eleventh element M11, and the fifteenth element M15) to be multiplied by the third element V1[2], the PIM command generator may generate a PIM command (e.g., the PIM command PIM_CMD). In other words, based on a predetermined non-zero element of the input vector V1 and a memory tile corresponding to the predetermined non-zero element, the PIM generator may generate a PIM command. The generated PIM command PIM_CMD may indicate multiplication between a column (e.g., a column including the third element M3, the seventh element M7, the eleventh element M11, and the fifteenth element M15) of a memory tile corresponding to a corresponding element and accumulation of respective multiplication results into the output vector V2. In FIG. 4B, multiplication and accumulation operations indicated by the PIM command PIM_CMD may be expressed by the equations in the execution operation column of Execution order 1. In FIG. 4B, V2 denotes the output vector V2, V2[0] denotes the first element of the output vector V2, V2[1] denotes the second element of the output vector V2, V2[2] denotes the third element of the output vector V2, and V2[3] denotes the fourth element of the output vector V2.

Based on the fourth vector V1[3] of the input vector V1 being zero, the PIM command generator may skip determining an address of a memory area corresponding to the fourth element V1[3] and may also skip generating a corresponding PIM command.

Accordingly, as illustrated in FIG. 4B, the PIM command generator may generate the PIM command PIM_CMD to perform a matrix-vector multiplication operation between the matrix M and the input vector V1. Compared to the generation of four PIM commands as described with reference to FIG. 4A, the PIM command generator that performs zero-skipping may generate PIM command(s) that may obtain the output vector V2 without any loss (i.e., while still getting the correct final result) using fewer PIM command(s). Furthermore, a PIM device that receives fewer PIM commands may efficiently operate with a fewer number of operations.

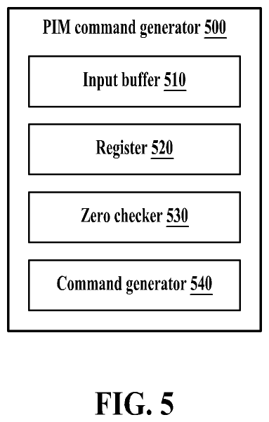

FIG. 5 illustrates an example of a configuration of a PIM command generator, according to one or more embodiments.

A PIM command generator 500 (e.g., the PIM command generator 121 of FIG. 1 and the PIM command generator 330 of FIG. 3) may include an input buffer 510 (e.g., the input buffer 122 of FIG. 1), a register 520, a zero checker 530, and a command generator 540.

The input buffer 510 may store input data. For example, the input buffer 510 may store an input vector serving as an operand of a matrix-vector multiplication operation.

The register 520 (possibly multiple registers) may store PIM device information. For example, the register 520 may store, as PIM device information, hardware information (e.g., the number of registers 520 that may be used for a PIM operation, the number of memory channels of a PIM device, or the number of memory ranks of the PIM device) of the PIM device, tiling information of the PIM device, and address mapping information.

The zero checker 530 may check whether each element of the input data stored in the input buffer 510 is zero or non-zero. The zero checker 530 may include a counter (not shown). The counter may point to which element corresponding to an index among the input data is to be checked as being zero or non-zero and may be increased to check each element of the input data one by one.

The command generator 540 may generate a PIM command based on information received from the input buffer 510, the register 520, and/or the zero checker 530. For example, the command generator 540 may generate a PIM command corresponding to a predetermined non-zero element, based on tiling information stored in the register 520 and based on whether the predetermined element of the input data received from (or analyzed by) the zero checker 530 is zero or non-zero.

Each of the input buffer 510, the register 520, the zero checker 530, and the command generator 540 may be implemented as a hardware module including one or more memory units and/or circuitry units.

FIG. 6 illustrates an example of a memory system including a DMA device, according to one or more embodiments.

A memory system 600 (e.g., the memory system 100 of FIG. 1) may include a host 610 (e.g., the host 110 of FIG. 1), a memory controller 620 (e.g., the memory controller 120 of FIG. 1 and the memory controller 300 of FIG. 3), a DMA controller 640, a DMA device 650, and a PIM device 630 (e.g., the PIM device 130 of FIG. 1).

The zero-skipping performed by a PIM command generator (e.g., the PIM command generator 121 of FIG. 1, the PIM command generator 330 of FIG. 3, and the PIM command generator 540 of FIG. 5) of the memory controller 620 (as described with reference to FIGS. 1 to 5) may also be performed by the DMA controller 640 of the memory system 600.

All or part of the configuration and operation of the DMA controller 640 and/or a PIM request generator 641 may be similar to or the same as all or part of the configuration and operation of the memory controller 620 and/or the PIM command generator described with reference to FIGS. 1 to 5. Hereinafter, the configuration and operation of the DMA controller 640 and/or the configuration and operation of the PIM request generator 641 are described.

The DMA controller 640 may include the PIM request generator 641. The PIM request generator 641 may include the input buffer 642. In response to a memory request received from the DMA device 650, the DMA controller 640 may generate a memory request and transmit the generated memory request to the memory controller 620. For ease of description, in FIG. 6, a memory request, a PIM request, and a standard memory request transmitted from the DMA device 650 to the DMA controller 640 may be referred to as an “input memory request”, an “input PIM request”, and an “input standard memory request”, respectively, and a memory request, a PIM request, and a standard memory request transmitted/outputted from the DMA controller 640 to the memory controller 620 may be referred to as an “output memory request”, an “output PIM request”, and an “output standard memory request”, respectively.

The PIM request generator 641 may receive, from the DMA device 650, a first input PIM request indicating to write input data to the input buffer 642. The PIM request generator 641 may store, based on the first input PIM request, the input data in the input buffer 642. The PIM request generator 641 may receive a second input PIM request indicating a PIM operation between the input data (now stored in the PIM device 630 per the first input PIM request) and data stored in the PIM device 630. The second input PIM request may indicate a matrix-vector multiplication operation between a matrix stored in a memory of the PIM device 630 and an input vector stored as input data in the input buffer 642.

The PIM request generator 641 may generate output PIM request(s) corresponding to a non-zero element(s) among the input data and may skip generating such PIM requests corresponding to zero element(s), and may do such skipping by scanning elements of the input data stored in the input buffer 642. The PIM request generator 641 may transmit the generated PIM request to the memory controller 620. The memory controller 620 may generate a PIM command based on the generated output PIM request and transmit the generated PIM command to the PIM device 630.

The PIM request generator 641 may determine, based on each element of the input vector being zero or non-zero, whether to determine an address of a memory area of the PIM device 630 corresponding to a corresponding element. The PIM request generator 641 may further include one or more registers that store at least one of tiling information of the PIM device 630, hardware information of the PIM device 630, or address mapping information. The PIM request generator 641 may determine an address of a memory area of the PIM device 630 corresponding to a predetermined element of an input vector using at least one of the hardware information, the tiling information, or the address mapping information.

The PIM request generator 641 may divide, based on the tiling information of the PIM device 630, a matrix into one or more memory tiles. With respect to each memory tile having an element to be multiplied by a predetermined non-zero element among the one or more memory tiles, the PIM request generator 641 may generate an output PIM request that indicates (i) multiplication between a predetermined element and a column corresponding to the predetermined non-zero element of a corresponding memory tile and (ii) accumulation of respective multiplication results into an element of a corresponding output vector.

For example, in response to a second input PIM request, the PIM request generator 641 may determine, based on a predetermined element among elements of the input vector being non-zero, a memory address of at least a portion of a matrix to be multiplied by the predetermined non-zero element. Based on a predetermined element among the elements of the input vector being zero, the PIM request generator 641 may skip determining the memory address of at least a portion of the matrix to be multiplied by a predetermined element of the memory of the PIM device 630.

The DMA controller 640 may further include an arbiter, a standard request generator, a DEMUX, one or more DMA channels, and a MUX. The arbiter of the DMA controller 640 may classify an input memory request received from the DMA device 650 as an input standard memory request or an input PIM request.

The arbiter may transmit, based on the input memory request being classified as an input PIM memory request, the input memory request to the PIM request generator 641. Based on receiving the input memory request from the arbiter, the PIM request generator 641 may generate an output PIM memory request.

The arbiter may transmit, based on the input memory request being classified as an input standard request, the input memory request to the standard request generator. Based on receiving the input memory request from the arbiter, the standard request generator may generate an output standard memory request.

A request generator (e.g., the standard request generator and the PIM request generator 641) may transmit the generated output memory request (e.g., the output standard memory request and the output PIM request) to a DEMUX. Based on information (e.g., a select signal) received from the arbiter and/or the request generator, the DEMUX may determine a DMA channel from among one or more DMA channels and store the output memory request in the determined DMA channel. One or more DMA channels may transmit the output memory request to the MUX. Based on information (e.g., a select signal) received from the memory controller 620 and/or the DMA device 650, the MUX may select a DMA channel from among one or more DMA channels and transmit the output memory request stored in the selected DMA channel to the memory controller 620.

Each of the arbiter, the PIM request generator 641, the standard request generator, the DEMUX, one or more DMA channels, and the MUX of the DMA controller 640 may be implemented as a hardware module including one or more memory units and/or circuitry units. Similarly, the PIM request generator 641 may include the input buffer 642, a register, a zero checker, and a request generator, and each of the input buffer 642, the register, the zero checker, and the request generator of the PIM request generator 641 may be implemented as a hardware module including one or more memory units and/or circuitry units.

The examples described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), RAM, flash memory, and the like (but not signals per se). Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

The computing apparatuses, the electronic devices, the processors, the memories, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media.

Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD−Rs, CD+Rs, CD−RWs, CD+RWs, DVD-ROMs, DVD−Rs, DVD+Rs, DVD−RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A processing in memory (PIM) command generator for a PIM device comprising:
an input buffer,
wherein the PIM command generator is configured to:
store input data into the input buffer in response to receiving, from a host, a first PIM request indicating to write the input data;
receive, from the host, a second PIM request indicating a PIM operation between the input data and data stored in the PIM device;
in response to the second PIM request, scanning elements of the input data stored in the input buffer to generate a PIM command corresponding to a non-zero element among the input data and to skip generating a PIM command corresponding to a zero element; and
transmit the generated PIM command to the PIM device.

2. The PIM command generator of claim 1, further comprising:
one or more registers configured to store scanning information comprising tiling information of the PIM device, hardware information of the PIM device, or address mapping information, wherein the scanning is performed based on the scanning information.

3. The PIM command generator of claim 1, wherein the second PIM request indicates a matrix-vector multiplication operation between a matrix stored in memory of the PIM device and an input vector stored as input data in the input buffer of the PIM device, and wherein the memory of the PIM device performs the matrix-vector multiplication operation.

4. The PIM command generator of claim 3, wherein the PIM command generator is configured to:
in response to the second PIM request, determine, based on a first element among the elements of the input vector being non-zero, a memory address of at least a portion of the matrix to be multiplied by the first element; and
based on a second element among the elements of the input vector being zero, skip determining a memory address of at least a portion of the matrix to be multiplied by the second element among the memory of the PIM device.

5. The PIM command generator of claim 4, wherein the PIM command generator is configured to:
based on tiling information of the PIM device, divide the matrix into one or more memory tiles;
with respect to each memory tile having an element to be multiplied by the first element among the one or more memory tiles, generate one PIM command indicating multiplication between the first element and a column of a corresponding memory tile corresponding to the first element and indicating accumulation of each multiplication result into an element of a corresponding output vector.

6. The PIM command generator of claim 1, wherein the PIM command generator is configured to:
based on information indicating each non-zero element among the input data and based on information about the PIM device, determine an address of a memory area corresponding to a corresponding element among memory of the PIM device; and
generate one or more PIM commands using the element and the address of the memory area.

7. The PIM command generator of claim 1, wherein the PIM command generator is configured to transmit one or more generated PIM commands to a memory command queue.

8. An electronic device comprising:
a processing in memory (PIM) command generator configured to generate, based on a PIM request received from a host, one or more PIM commands configured to implement the PIM request when executed by a PIM device,
wherein the PIM command generator comprises an input buffer, and
wherein the PIM command generator is configured to:
store the input data in the input buffer in response to receiving a first PIM request indicating to write input data;
receive a second PIM request indicating a PIM operation between the input data and data stored in a PIM device;
in response to the second PIM request, scanning elements of the input data stored in the input buffer to determine to skip generating a PIM command corresponding to a first element of the input data based on the first element being zero and to determine to generate a PIM command corresponding to a second element of the input data based on the second element being non-zero; and
transmit the generated PIM command to the PIM device.

9. The electronic device of claim 8, further comprising:
an arbiter configured to determine whether to classify a memory request received from the host as a standard memory request or as a PIM request; and
a standard command generator,
wherein the arbiter is configured to:
based on classifying a first memory request as a standard memory request, transmit the first memory request to the standard command generator; and
based on classifying a second memory request as a PIM request, transmit the second memory request to the PIM command generator,
wherein the standard command generator is configured to generate a standard memory command based on receiving the first memory request from the arbiter, and
wherein the PIM command generator is configured to generate the one or more PIM commands based on receiving the second memory request from the arbiter.

10. The electronic device of claim 8, wherein the PIM command generator further comprises one or more registers configured to store scanning information comprising tiling information of the PIM device, hardware information of the PIM device, or address mapping information, wherein the scanning is performed based on the scanning information.

11. The electronic device of claim 8, wherein the second PIM request indicates a matrix-vector multiplication operation between a matrix stored in a memory of the PIM device and an input vector stored as input data in the input buffer.

12. The electronic device of claim 11, wherein
generating the PIM command comprises determining a memory address of at least a portion of the matrix to be multiplied by the first element.

13. The electronic device of claim 12, wherein the PIM command generator is configured to:
based on tiling information of the PIM device, divide the matrix into one or more memory tiles; and
with respect to each memory tile having an element to be multiplied by the first element among the one or more memory tiles, generate one respective PIM command indicating multiplication between the first element and a column of a corresponding memory tile corresponding to the first element and indicating accumulation of each multiplication result into an element of a corresponding output vector.

14. The electronic device of claim 8, wherein the PIM command generator is configured to:
determine, based on information indicating each non-zero element among the input data, information about the PIM device, an address of a memory area corresponding to a corresponding element, the memory area in memory of the PIM device; and
generate one or more PIM commands using the element and an address of the memory area.

15. The electronic device of claim 8, further comprising:
a memory command queue,
wherein the PIM command generator is configured to transmit the generated one or more PIM commands to the memory command queue.

16. The electronic device of claim 8, further comprising:
a standard command generator;
a standard memory command queue; and
a PIM command queue,
wherein the PIM command generator is configured to transmit the generated one or more PIM commands to the PIM command queue, and
wherein the standard command generator is configured to generate, based on a standard memory request received from the host, a standard memory command and then transmit the generated standard memory command to the standard memory command queue.

17. The electronic device of claim 16, further comprising:
a scheduler connected to the standard memory command queue and the PIM command queue,
wherein the scheduler is configured to:
determine, through scheduling, one queue among the standard memory command queue or the PIM command queue; and
transmit, to the PIM device, at least one of the standard memory command or the PIM command received from the determined one queue.

18. A method of generating a memory command, the method performed by a processing in memory (PIM) command generator configured to generate commands to be executed by a PIM device, the method comprising:
storing input data into an input buffer of the PIM command generator, the storing in response to receiving, from a host, by the PIM command generator, a first PIM request indicating to write input data;
receiving, from the host, by the PIM command generator, a second PIM request indicating a PIM operation between the input data and data stored in the PIM device;
in response to the second PIM request, scanning elements of the input data stored in the input buffer, and based on the scanning generating a PIM command corresponding to a non-zero element among the input data and further based on the scanning skipping generating a PIM command corresponding to a zero element; and
transmitting, by the PIM command generator, the generated PIM command to the PIM device.

19. The method of claim 18, wherein the second PIM request is configured to indicate a matrix-vector multiplication operation between a matrix stored in a memory of the PIM device and the input vector stored as the input data in the input buffer.

20. A non-transitory computer-readable storage medium storing commands that, when executed by one or more processors, cause the one or more processors to perform the method of claim 18.
